(19) United States
(12) Patent Application Publication
(10) Pub. No.: US 2011/0102314 A1
(43) Pub. Date: May 5, 2011

(54) Dual-screen electronic reader with tilt detection for page navigation

(75) Inventor: Claude C. Roux, Grenoble (FR)

(73) Assignee: Xerox Corporation, Norwalk, CT (US)

(21) Appl. No.: 12/609,818

(22) Filed: Oct. 30, 2009

(51) Int. Cl. G06F 3/01

(52) U.S. Cl. 345/156

(57) ABSTRACT

A dual screen electronic reader and method for navigating a document are disclosed. The electronic reader includes two display screens which can be angled to each other, like an open book, for viewing by a person reading the document. The electronic reader includes a tilt detection system for detecting tilting of the electronic reader indicative that the reader has completed reading the page on the first screen and has pivoted the electronic reader to view the opposite screen. This causes the electronic reader to load a fresh page on the first screen, optionally after a short time delay, which allows for counter-rotational tilting to be taken into consideration.

### BACKGROUND

Electronic readers, also known as e-readers, e-book readers or e-book devices, are portable electronic devices used to display electronic documents, such as books and reports. Such devices are typically battery operated and have a screen which has good readability, despite a relatively small size. With the development of E-ink technology, which offers crisp and clear images even in sunlight, e-readers have now become more feasible as replacements for conventional paper books. Screens employing E-ink technology include a film of microcapsules, each capsule containing a mixture of black and white particles which respond differently to the imposition of magnetic fields. The black particles move in one direction to become visible as a dot or in another to be hidden from view.

E-readers display only a single page of a document on the screen at any time. The user reads the page and then “turns” to the next page of the document by pressing a button or performing touch screen hand movements. As a result, it is difficult to compare the content of two pages, which has some disadvantages when compared with a conventional book format, particularly when the content of one page is intended to be viewed in tandem with the content of the other.

Additionally, there are some drawbacks to the E-ink technology. One of these is the latency between two pages. The system fully resets the screen before displaying the next page. This latency is typically between a half and one second, which is perfectly perceptible for most users. Another problem is the flash which occurs with the resetting of the screen. The screen toggles from white to black then back to white to erase the full content of that screen, before displaying a new page. This can be disconcerting to users.

Dual screen e-readers have been proposed. For example, Chen, N., Guimbretiere, F., Dixon, M., Lewis, C., & Agrawala, M., Navigation techniques for dual-display e-book readers, CHI 2008, Apr. 5-10, Florence, Italy (2008), suggests a dual display e-book reader. Two different ways of interacting with this e-reader are proposed: the flip approach, where the user switches from one page to the other by flipping the device over (turning it upside down) to view the screen on the other side of the device; and the fanning approach, in which the movement involved in reading a magazine is imitated by rotating one screen towards the other one and back again. If the left screen is moved, then the e-reader goes backward, while if the right screen is moved the e-reader goes forward. While such techniques may be an improvement over other e-readers, they still entail many manipulations.

### INCORPORATION BY REFERENCE

The following references, the disclosures of which are incorporated in their entireties by reference, are mentioned:

U.S. Pat. No. 7,548,220, issued Jun. 16, 2009, and U.S. Pub. No. 20090236411, published Sep. 24, 2009, entitled FOLDABLE ELECTRONIC BOOK, by Kia Silverbrook, discloses an electronic book with two housing portions and a cylindrical spine interposed between the first and second housing portions. A flexible display screen with inner faces of the first and second housings spans the spine. The spine defines a recess to accommodate a curvature of the screen intermediate the first and second portions, when the portions are in a closed condition.

U.S. Pub. No. 2003/0076343, published Apr. 24, 2003, entitled HANDEDNESS DETECTION FOR A PHYSICAL MANIPULATORY GRAMMAR, by Kenneth P. Fishkin, et al., discloses a display device responsive to user manipulations, such as tilting and squeezing.

U.S. Pub. Nos. 20090219248 and 20090222756, published Sep. 3, 2009, entitled ELECTRONIC DEVICE CAPABLE OF SHOWING PAGE FLIP EFFECT AND METHOD THEREOF, by Xiao-Guang Li, et al., disclose a method for showing page flip effect when using an electronic device.

U.S. Pat. No. 7,231,825, issued Jun. 19, 2007, entitled ACCELEROMETER BASED TILT SENSOR AND METHOD FOR USING SAME, discloses a tilt sensor and a method of use of the tilt sensor to calculate the degree of tilt. The tilt sensor has at least three accelerometers mounted to a base and positioned in a common plane.

### BRIEF DESCRIPTION

In accordance with one aspect of the exemplary embodiment, an electronic reader includes a first panel comprising a first display screen for displaying a page of a document and a second panel comprising a second display screen for displaying another page of the document. The second panel is connected with the first panel, whereby the first panel is pivotable, relative to the first panel, from a first position in which the display screens are facing to a second position in which the display screens are angled, relative to each other. A tilt detection system includes one or more sensors for detecting tilting of the electronic reader. A navigation system alternately loads fresh pages of the document onto the first and second screens in response to detected tilting.

In another aspect, a method for navigating an electronic reader includes displaying a page of a document on a first display screen of an electronic reader and displaying another page of the document on a second display screen of the electronic reader, the second display screen being angled to the first screen at an angle of less than 180°. The method further includes automatically detecting tilting of the electronic reader about an axis substantially parallel to the spine and, in response to the detected tilting, loading a fresh page of the document onto one of the first and second screens, whereby pages are loaded alternately onto the first and second screens.

In another aspect, a dual screen electronic reader includes first and second panels bound to each other at a spine, the first and second panels each including a display screen, the panels and the spine cooperating to prevent the display screens from being angled to each other at greater than a fixed angle of less than 180°. A sensor detects tilting of the electronic reader relative to at least one reference plane. A navigation system is configured to automatically load a fresh page of a document onto the first screen after a first delay period following a first detected tilting and load another fresh page of the document onto the second screen after a second delay period following a second, opposite tilting.

### BRIEF DESCRIPTION OF THE DRAWINGS

FIG. 1 is a perspective view of an e-reader open for reading, in the hands of a reader, in accordance with one aspect of the exemplary embodiment;

FIG. 2 is a perspective view showing the e-reader in a closed position;

FIG. 3 is a schematic, cross sectional view of the e-reader of FIGS. 1 and 2;

FIG. 4 is a schematic, cross sectional view of the e-reader in accordance with another embodiment;

FIG. 5 is a schematic, cross sectional view of the e-reader in accordance with another embodiment;

FIG. 6 is a functional block diagram of the e-reader; and

FIG. 7 illustrates a method for navigating the pages of the e-reader in accordance with another aspect of the exemplary embodiment.

### DETAILED DESCRIPTION

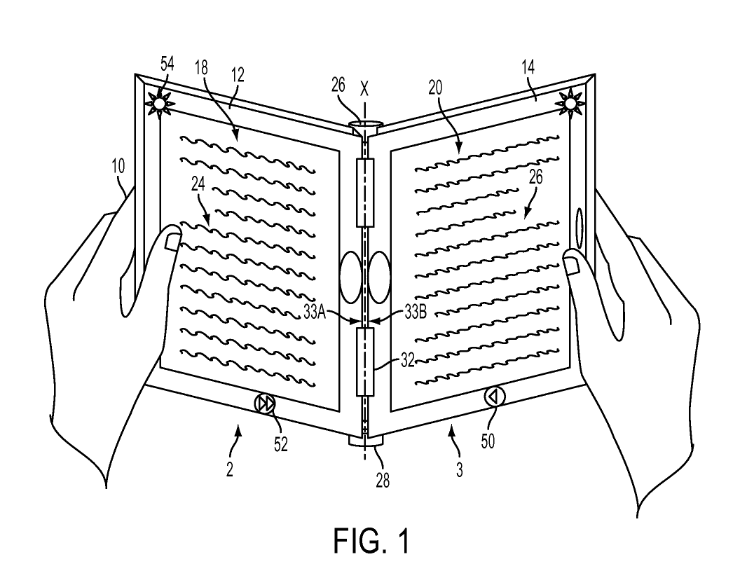

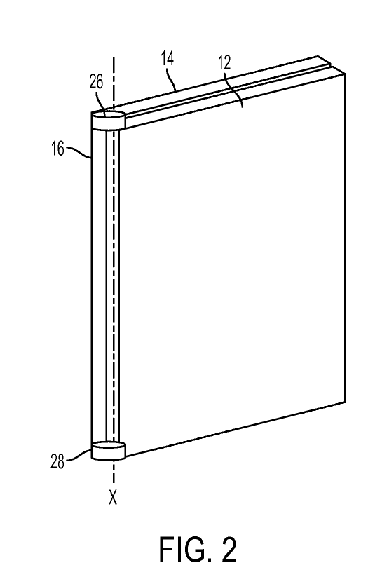

With reference to FIG. 1, a dual screen electronic reader (e-reader) 10 is shown. The device 10 includes first and second generally planar display panels 12, 14, and a spine 16 intermediate the two panels 12, 14, through which electrical connections are made. The display panels 12, 14 are able to pivot, relative to each other, about the spine 16, to open and close the e-reader 10. FIG. 1 illustrates the e-reader in an open position in which first and second visual display screens 18, 20, one in each display panel, are visible to the reader. The panels 12, 14 can be moved to a closed position, as shown in FIG. 2, in which the screens are no longer visible.

Each display screen 18, 20 can display a respective page of text 22, 24 contemporaneously with a different page of text being displayed on the other screen. The screens 18, 20 can be of any suitable size. In general, a height h is greater than a width w of the screen. For example, both screens, which are the same size, may have an active area of from about 10-25 cm in width w and from 12 to 30 cm in height h. The spine can 16 be generally cylindrical and bound to the two panels 12, 14 through end caps 26, 28, at ends of the spine.

In one embodiment, each screen 18, 20 employs E-ink technology. Such screens include a thin film containing microcapsules and are available from E Ink Corporation, 733 Concord Avenue, Cambridge, Mass. 02138. Each screen may have a pixel count of from about 800×600 to 1200×825 and dots per inch (dpi) of from about 120-300. Each pixel corresponds to a microcapsule containing black and white particles. In other embodiments, other display screens are contemplated, such as liquid crystal display (LCD), light emitting diode (LED), and plasma screens.

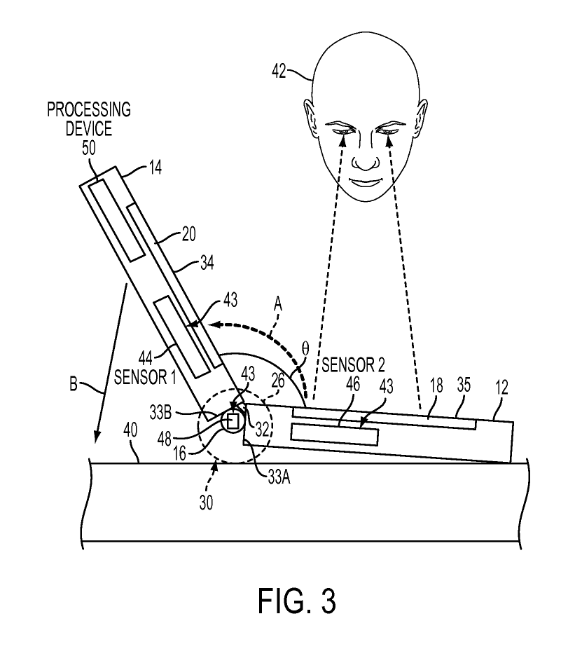

With reference also to FIG. 3, the device allows a maximum angle θ between the screens 18, 20. In one embodiment, θ is less than 180°, such as from about 100°-160°. In one specific embodiment, θ is no greater than about 135° or 140° to avoid instability. An angle θ of about 120° is exemplary. The maximum angle θ to unfold the device 10 may, however, depend on the thinness of the two panels.

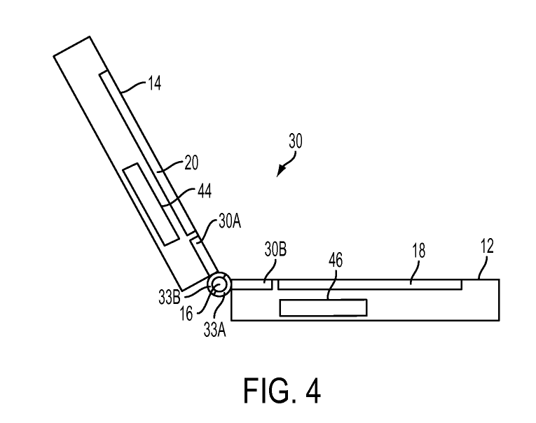

A panel angle control mechanism 30 prevents the panels 12, 14 from being opened beyond the maximum angle (absent excessive force). Various mechanisms 30 for establishing the maximum angle are contemplated. In the embodiment illustrated in FIG. 3, the mechanism 30 is provided by cooperation between the spine 16 and the two panels 12, 14, which are bound together at the inner edges by a binding 32. In one embodiment, the binding may be a flexible binding, such as a rubber or plastic strip. In another embodiment shown in FIG. 4, which may be similarly configured to the e-reader of FIGS. 1-3, except as noted, the panels 12, 14 are joined together by one or more hinges 30. Each hinge includes hinge plates 30A, 30B, fixed to the respective panels 12, 14 near their adjacent side edges 33A, 33B. In this embodiment, the spine 16 may provided by the hinge joint.

The mechanism 30 prevents the user from fully unfolding the e-reader 10. As the panels 12, 14 are moved apart in the direction of arrow A, outer edges of the panels 12, 14 come into contact with the spine 16, which prevents further movement. The angle θ represents the maximum angle subtended between the planar display surfaces 34, 35 of the two panel screens. In one embodiment, the mechanism 30 includes a soft lock (not shown) which, once the reader has opened the e-reader to the maximum angle, retains the e-reader at the fixed maximum angle θ, inhibiting variation in the angle between the panels until sufficient pressure is placed on the panels or a release mechanism is actuated, to return the e-reader to the closed position.

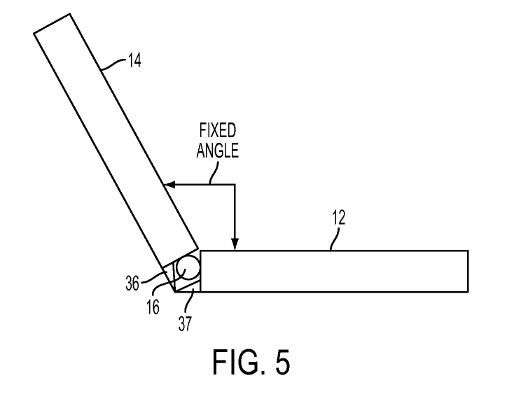

FIG. 5 shows another embodiment of an e-reader including a different mechanism 30 for controlling the maximum angle of opening θ. The e-reader of FIG. 5 may be similarly configured to the e-reader of FIGS. 1-3, except as noted. In this embodiment, the mechanism 30 includes projections 36, 37, which extend from the panels 12, 14. The projections may be provided by giving the abutting end walls of the panels 12, 14 a curvature which follows that of the spine. When the e-reader is opened, tips of the projections contact each other, preventing the e-reader form being opened beyond fixed angle θ.

In each of the embodiments shown, the mechanism 30 obliges, in a natural way, the user to tilt the e-reader either to the left or to the right to read the appropriate page easily. Thus, when one panel 12 of the e-reader is placed on a flat horizontal surface 40, such as a desk or table top, the adjoining panel 14 is raised above the surface at an angle of approximately 180-θ°. In this position, the e-reader is stable, without interaction of the user. The reader 42 can readily view screen 18, but can also, by tilting the head, read screen 20.

When the e-reader 10 is tilted in the direction of arrow B to a position in which the panel 14 is in contact with the flat surface, i.e., the mirror image of FIG. 3, panel 12 is raised upward, away from the surface 40, and the e-reader is once again stable without interaction of the user. During tilting, the e-reader is pivoted about an axis x substantially parallel to the length of the spine, e.g., axis x is no more than 10° from an axis of the spine. In the exemplary embodiment, this simple one-directional rotational movement is all that is required to change the page displayed on the newly-raised panel. The page displayed on the horizontal panel is unchanged. The angle between the two screens remains constant at angle θ during this page change initiating movement. There is no need to move one screen relative to the other to cause the next page to be loaded, and in one embodiment, such movement is inhibited or prevented.

As will be appreciated, the positioning of the e-reader 10 on a flat surface in FIG. 3 is for illustration purposes, the e-reader can alternatively be held in the hands of the reader 42, as illustrated in FIG. 1.

As shown in FIG. 3, a tilt detection system 43 detects when the e-reader is tilted (i.e., the when the panels are moved to a different angle relative to a reference plane, such as horizontal and/or vertical). In the exemplary embodiment, the tilt detection system 43 includes laterally and angularly spaced sensors 44, 46, 48. In one embodiment, each panel includes a respective sensor 44, 46, which detects the angle of the panel with respective to a fixed reference plane (a position sensor), such as the horizontal or detects a change in that angle (a motion sensor). Optionally, the tilt detection mechanism includes a third sensor 48, which is carried by the spine 16, e.g., mounted within it or to one of its ends. In another embodiment, rather than two sensors 44, 46, only a single sensor 44 or 46 is provided in one of the two panels. The position of the other panel can then be determined from the position of the other, assuming that the e-reader is fixed at angle θ. Sensor 48 and optionally also sensors 44 and 46, may each include one or more accelerometers, electrolytic or mercury tilt sensors (inclinometers), or other device capable of detecting tilting of the e-reader in the direction of arrow A, either indirectly or directly.

In the case of an accelerometer as a sensor, the rotational movement of the sensor 44, 46 as the panel 12, 14 is raised or lowered is registered as acceleration and a signal is output by the respective sensor. Sensor 48 detects rotation of the spine 16. Accelerometers act under the acceleration of gravity and sense deviations in the gravitational field. Specifically, as an accelerometer is tilted at an angle with respect to the horizontal, the vertical component of the force of gravity acting on the accelerometer changes, causing the electronic components within the accelerometer to react differently, and varying the output reading of the accelerometer. Some accelerometers utilize a piezoelectric crystal and a mass whereby the changing angle of inclination causes the mass to apply varying pressure on the piezoelectric crystal, which produces the output signal. In other accelerometers, a capacitor and resistor are used to effectively create a mass-spring system whereby the output signal varies under the force of gravity with the tilt angle.

An electrolytic tilt-sensor is based on an electrolyte bordered on two sides by a pair of conductive plates. As the device is angled towards or away from either plate, the amount of electrolyte in contact with the plate varies. The area of fluid in contact with each plate will affect the impedance presented by the contacts of the sensor. By monitoring this impedance and converting its change into a voltage, a simple ADC interface to a microcontroller can capture the data and then process it.

In one embodiment, the tilt sensor 48 is calibrated to detect (output) only tilting movements wider than a certain angle to a reference plane such as the horizontal.

In one embodiment, the position sensors 44, 46 are able to detect the position, relative to the horizontal, of each screen independently. These sensors add precision to the device tilt detection, by providing, after each movement of the e-reader, the actual angle to the horizontal for each screen. A single sensor in one single screen can replace the two sensors where two screens are firmly bound to each other and locked at a fixed angle. The position of one screen can then be used to compute an angle of the other screen in space.

Page reloading occurs in response to detection of tilt. However, tilt sensors, such as accelerometers are often very sensitive to manipulation. Thus, a user could turn the e-reader slightly and this could cause the page to change without the user intending it to do so. The exemplary dual screen device 10 takes into account the tilt in a way which overcomes these potential problems. First, the dual screen device moves to the next page in two steps. In the first step, tilt is detected. In the second step, after a predetermined delay, the page navigation system goes to the next page. By allowing a delay between tilt detection and page loading, this reduces the impact of movements by the user that are not intended to initiate a page change and which, when reversed, reset the system.

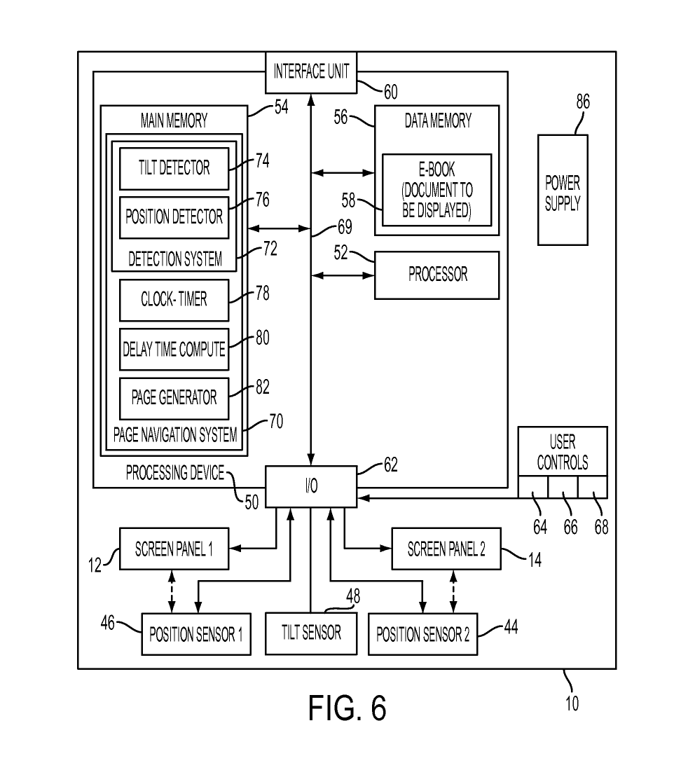

FIG. 6 is a schematic functional block diagram of the device 10, illustrating the interconnection between the operational components of the e-reader and the controls.

The e-reader 10 includes a processing device 50 which hosts various electronic components of the e-reader. The processing device 50 may be physically located in one the two panels 12, 14 or the spine 16, or distributed among two or more of them. Processing device 50 includes a processor 52, which controls the overall operation of the e-reader, by execution of software stored in main memory 54. Data memory 56, separate from or integral with main memory 54, may be used for temporary storage of e-books 58, or other electronic documents, which are to be displayed pagewise on the dual screens 18,20. An interface unit 60 allows e-books to be loaded into memory either wirelessly, e.g., over the Internet, or through a wired connection or input port for a digital storage device, such as a USB port or memory card reader. An input/output unit 62 allows the processing device to communicate with other components of the e-reader, including the first and second screens 18, 20, sensors 44, 46, 48 and optionally with one or more user control devices, such as buttons 64, 66, 68. The various components 52, 54, 56, 60, 62 of the processing device 50 communicate with each other, and with external components, via a data/control bus 69.

The memories 54, 56 may represent any type of tangible computer readable medium such as random access memory (RAM), read only memory (ROM), magnetic disk or tape, optical disk, flash memory, or holographic memory. In one embodiment, the memory 54, 56 comprises a combination of random access memory and read only memory. The digital processor 52, which is a physical device, can be variously embodied, such as by a single-core processor, a dual-core processor (or more generally by a multiple-core processor), a digital processor and cooperating math coprocessor, a digital controller, or the like. In some embodiments, the processor 52 and memory 54, 56 may be combined in a single chip.

The exemplary page navigation system 70 includes software instructions stored in main memory 54, which are executed by processor 70, including instructions for sequentially and alternately loading fresh pages onto the first and second screens in response to detected tilting. The software components are illustrated as a set of separate components, although it is to be appreciated that these may be combined or split according to functionality. In the exemplary embodiment, a first component 72 is a tilt detection system for detecting tilting movements of the e-reader. System 72 may include a tilt detector 74 and a position detector 76. The tilt detector 74 receives signals representative of tilting movements from the tilt sensor 48. The position detector 76 receives signals from the position sensors 44, 46. In one embodiment, the detection system detects which of the two screens is the most horizontal, based on signals from sensors 44, 46 or an additional sensor(s).

Based on the signals received from the various sensors, the system 72 determines whether the e-reader has been tilted and, optionally, which panel is the closest to horizontal, i.e., the page being read. A clock/timer 78 starts a timing routine each time a tilt is detected by the tilt detection system. The clock is stopped if the system 72 reports a reverse movement. A time delay computing component 80 determines a suitable time for delaying the loading of the next page, which may be based on user inputs, frequency of tilt movements, and the like. A page generator 82 generates each page in turn and loads it to the screen, when authorized by the time delay computing component 80.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

Power for the e-reader may be provided by a power source such as a battery 86.

As will be appreciated, FIG. 6 is a high level functional block diagram of only a portion of the components which are incorporated into an e-reader 10. As will be appreciated, the e-reader may include other components conventional in e-reading devices, such as a power switch, keypad, modem, radio transmitter, and the like.

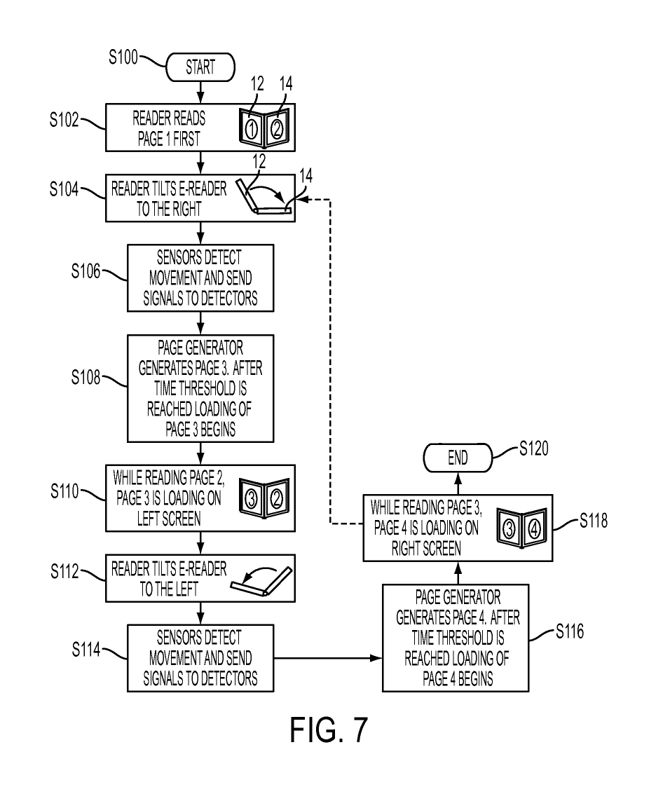

FIG. 7 illustrates a method of operating the electronic reader 10. The method begins at S100. The reader opens the e-reader by moving the panels from a first position in which the display screens are facing (angled at around 0° to each other) to a second position, which locks the screens at the fixed angle θ. In a conventional manner, the user selects, e.g., via a displayed menu, a document 58 to read from those stored in memory 56, or otherwise accessible to the e-reader. At S102 the page generator 82 generates the first two pages 1 and 2 to be displayed. These pages are displayed on the two screens Page 1 can be loaded into the most horizontal screen 18 in panel 12 first, followed by loading of page 2 on panel 14. The reader begins reading page 1 and when this completed, at S104, tilts the e-reader in a first direction (to the right) and begins reading page 2.

At S106 (which may take place before or while page 2 is being read) the sensors 44, 46, 48 detect the tilt movement of the e-reader and send signals to the detectors 74, 76. At S108, the page generator generates 82 the next page (page 3). The clock 78 begins timing and, once a delay time has elapsed, delay compute component 80 prompts the page generator to update the first screen 18 with a fresh page of the document. At S110, the replacement of page 1 with page 3 commences. The delay time may be, for example, at least 10 seconds, e.g. from 20 to 40 seconds. However, if during the delay time, a counter-movement of a similar angle is detected, the loading of the page is terminated until a further movement in the first direction is detected, when the clock starts again.

At S112, while the reader is reading page 2, the loading of page 3 is completed. Thus, when the user tilts the e-reader in a second direction (now to the left) to read the left page 3, the e-reader is already positioned on the next page. As for S106, at S114, the sensors 44, 46, 48 detect the tilting movement. The page generator 82 generates the next page (page 4). After a delay of 20 to 40 seconds, the e-reader then starts the update of the right screen 20 with page 4 (S116). While the reader reads page 3, the update of page 4 is completed (S118). The method then returns to S104 and the process is repeated for each page of the document 58, or until the reader decides to stop reading. The method ends at S120.

The method illustrated in FIG. 7 may be implemented in a computer program product that may be executed on a computer. The computer program product may be a computer-readable recording medium on which a control program is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use. Alternatively, the method may be implemented in a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 7, can be used to implement the method for navigating an e-reader.

Additional features may be provided on the e-reader, as follows:

Reading backward: To read backward, a “reverse” button 64 (FIG. 1) may be provided on the e-reader to invert the reading direction in the document. For example, if the button 64 is pushed while the e-reader is tilted, then the system displays the pages backward.

Fast forward: A “fast forward” button 66 may be provided for implementing a fast forward mechanism. Alternatively or additionally, one or more of the detectors 74, 76 may be configured to recognize the swinging of the e-reader from left to right a few times in a row as a signal to fast forward through the book.

Forcing the Display of a Page: A button 68 (or one button for each screen) may be provided to force the update of a page (overriding the automatic time delay).

As alternatives to the buttons 64, 66, 68 illustrated in FIG. 1, the screens may be touch sensitive and include touch responsive areas displaying the buttons 64, 66, 68 or may be responsive to certain gestures, such as a finger drawn quickly across the screen in a given direction, which signals the turn of the page.

Timer calibration: While in the exemplary embodiment the update time is fixed at a default value, in another embodiment, it may adapt to reader usage. For example, the system 70 may detect the frequency/time period of page turning by the reader and determine a shorter update time than the default time such that it is well within the determined reader's time period for reading each page. Periodically, the update time may be recalibrated based on the times at which the last few pages were turned.

Update of a page using E-ink technology is relatively slow, e.g., about 500 ms. In this time, a reader may read a few words. The time delay is thus selected to accommodate the time required for loading the next page. The new page should then be loaded and ready for viewing before or as the previous page is tilted. Additionally or alternatively, the system may learn from the feedback provided by the page forward button 68. If the user presses the button frequently to force the update of a page, this suggests that the time delay should be shortened. In one embodiment, the time delay is calibrated with each use or at other intervals, by having the user force the page update, by pressing the button 68, for a few pages.

Right Screen Update: Because readers (except in some languages) are used to reading from right to left, the presence of a prior page on the right hand screen 20, while the user is reading the left hand screen, may cause some confusion. For example, as the user begins to read page 3 on the left screen 18, page 2 is still present on the right screen 20. Accordingly, the update of the right screen 20 may be faster (i.e., a shorter update delay) than for the left screen 18.

The exemplary page turning method provides advantages over other proposed approaches. First, the exemplary method does not require manipulation of the screens relative to one another, which could lead to damage to the spine or binding over time. The only movement needed in the exemplary embodiment is a tilt of the entire e-reader to the left or to the right, which is a natural movement for users when they need to turn a page.

Additionally, the use of a delay mechanism and the use of more than one sensor allows the reader to move the e-reader slightly without resulting in an undesired page turn. In this way, the mechanism is not overly sensitive to tilt movements which the user did not intend as a page turning motion.

In a single screen device with a tilt sensor, the sensor tends to be very sensitive to every movement. One problem with this is that a screen update on an E-ink device is slow and consumes much more energy than on a conventional screen. However, once a page is displayed, no energy is required to maintain the page, hence the overall energy efficiency of the device is generally higher than for conventional screens. A tilt detector in a single screen device that would translate into a new page for each movement would be a problem for users as well as for the efficiency of the device.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An electronic reader comprising:
a first panel comprising a first display screen for displaying a page of a document;
a second panel comprising a second display screen for displaying another page of the document, the second panel being connected with the first panel, whereby the first panel is pivotable, relative to the first panel, from a first position in which the display screens are facing to a second position in which the display screens are angled, relative to each other;
a tilt detection system comprising at least one sensor which detects tilting of the electronic reader; and
a navigation system which alternately loads fresh pages of the document onto the first and second screens in response to detected tilting.

2. The electronic reader of claim 1, wherein the navigation system delays loading a page for a delay time following detection of tilting.

3. The electronic reader of claim 2, wherein when an opposite tilting is detected prior to expiration of the delay time, the page loading is cancelled.

4. The electronic reader of claim 1, wherein the first and second panels are connected, at side edges of the panels, to a spine.

5. The electronic reader of claim 1, wherein in the second position, a locking mechanism maintains a fixed angle between the panels during tilting.

6. The electronic reader of claim 1, wherein in the second position, the first and second display screens are angled to each other at a maximum angle of no greater than 160°.

7. The electronic reader of claim 6, wherein in the second position, the first and second display screens are angled to each other at a maximum angle of no greater than 140°.

8. The electronic reader of claim 1, wherein the at least one sensor includes a first sensor associated with the first panel, a second sensor intermediate the first and second panels, and optionally a third sensor associated with the second panel.

9. The electronic reader of claim 1, wherein one of the sensors comprises an accelerometer.

10. The electronic reader of claim 1, wherein the navigation system sequentially loads pages onto whichever of the first and second screens is angled greater to a horizontal reference plane.

11. The electronic reader of claim 1, wherein the navigation system comprises software instructions stored in memory which are executed by a processor of the electronic reader.

12. The electronic reader of claim 1, further comprising a user input device for overriding the time delay.

13. The electronic reader of claim 1, further comprising memory which stores the electronic document to be displayed.

14. A method for navigating an electronic reader comprising:
displaying a page of a document on a first display screen of an electronic reader;
displaying another page of the document on a second display screen of the electronic reader, the second display screen being angled to the first screen at an angle of less than 180°;
automatically detecting tilting of the electronic reader about an axis substantially parallel to the spine; and
in response to the detected tilting, loading a fresh page of the document onto one of the first and second screens, whereby pages are loaded alternately onto the first and second screens.

15. The method of claim 14, wherein during tilting, the first and second screens remain angled to each other at a fixed angle.

16. The method of claim 14, wherein the loading of the fresh page is performed after a time delay following the detection of tilting.

17. The method of claim 16, wherein where a second tilting of the electronic reader is detected in a counter direction to that of the first tilting, the loading of the fresh page is cancelled.

18. The method of claim 16, wherein a delay time for loading pages onto the first screen is different from a delay time for loading pages onto the second screen.

19. The method of claim 14, wherein the detecting of the tilting includes receiving sensor signals from a plurality of sensors associated with the electronic reader.

20. A computer program product encoding instructions, which when executed on a computer causes the computer to perform the method of claim 14.

21. A dual screen electronic reader comprising:
first and second panels bound to each other at a spine, the first and second panels each including a display screen, the panels and the spine cooperating to prevent the display screens from being angled to each other at greater than a fixed angle of less than 180°;
a sensor which detects tilting of the electronic reader relative to at least one reference plane; and
a navigation system which is configured to automatically load a fresh page of a document onto the first screen after a first delay period following a first detected tilting and load another fresh page of the document onto the second screen after a second delay period following a second, opposite tilting.

22. The method of claim 21, wherein the first and second delay periods are different.
